(19) United States
(12) Patent Application Publication
(10) Pub. No.: US 2026/0050253 A1
(43) Pub. Date: Feb. 19, 2026

(54) NEURAL NETWORK-BASED ERROR COMPENSATION METHOD FOR MASS TRANSFER OF MINI-LIGHT-EMITTING DIODE (MINI-LED) CHIPS

(71) Applicant: Guangdong University of Technology, Guangzhou (CN)

(72) Inventors: Yun CHEN, Guangzhou (CN); Xiangyuan LUO, Guangzhou (CN); Li MA, Guangzhou (CN); Zilin HE, Guangzhou (CN); Jiawei XIAO, Guangzhou (CN); Maoxiang HOU, Guangzhou (CN); Xin CHEN, Guangzhou (CN)

(21) Appl. No.: 19/370,684

(22) Filed: Oct. 27, 2025

(30) Foreign Application Priority Data
Nov. 4, 2024 (CN) 202411561170.7

(51) Int. Cl. G05B 19/418

(52) U.S. Cl. CPC G05B 19/4189; G05B 2219/32335; G05B 2219/39147

(57) ABSTRACT

A neural network-based error compensation method for mass transfer of mini-light-emitting diode (Mini-LED) chips includes the following steps. (S1) An automated optical re-inspection result is obtained as a first result. (S2) The first result is sorted and normalized to obtain a second result. (S3) Nearest-neighbor interpolation is performed on a Mini-LED chip with a transfer status identifier being abnormal, and a differential of path variables of each Mini-LED chip is calculated. (S4) A multi-layer neural network model is defined. A loss function is constructed. A weight of the multi-layer neural network model is updated with the loss function, until no overfitting is observed. (S5) A chip transfer path is generated and input into the multi-layer neural network model to obtain a predicted transfer error value, and mass transfer of the Mini-LED chip is performed based on the predicted transfer error value.

### CROSS-REFERENCE TO RELATED APPLICATIONS

This application claims the benefit of priority from Chinese Patent Application No. 202411561170.7, filed on Nov. 4, 2024. The content of the aforementioned application, including any intervening amendments thereto, is incorporated herein by reference in its entirety.

### TECHNICAL FIELD

This application relates to chip transfer and packaging technologies, and more particularly to a neural network-based error compensation method for mass transfer of mini-light-emitting diode (Mini-LED) chips.

### BACKGROUND

Mass transfer refers to a process of transferring a large number of mini-light-emitting diodes (Mini-LEDs) from their growth wafer to a designated display substrate. Due to the extremely small size of Mini-LED chips, it is critical to ensure that each Mini-LED chip is accurately placed at its predetermined position. Excessive transfer error may lead to defects, such as poor electrical contact or high missing die rate. Moreover, high transfer efficiency is necessary to the large-scale production. The small size and high transfer frequency of the Mini-LED chips make sources of transfer errors more complex, and make it difficult to accurately quantify the errors through mathematical models. Pick-and-place technique is one of the main categories of Mini-LED mass transfer technologies, in which relative positions among the needle, wafer, and glass substrate are adjusted to control an overall translation of Mini-LED chip landing positions.

However, such a compensation method can only minimize an average transfer error of the Mini-LED chips but cannot control the transfer error of individual chips. In addition, due to high frequency of mass transfer, it is impractical to perform camera-assisted positioning for each Mini-LED chip prior to ejection, therefore, it is urgently needed to develop a mass transfer error compensation method which can apply pre-compensation to each Mini-LED chip before the transfer.

### SUMMARY

In view of the above defects, this application provides a neural network-based error compensation method for mass transfer of mini-light-emitting diode (Mini-LED) chips, in which a multi-layer neural network is trained with existing transfer results, and a motion path is exported and input into the multi-layer neural network before the transfer to obtain a predicted transfer error, so as to modify the motion path based on the predicted transfer error to achieve the error pre-compensation.

In order to achieve the above purposes, technical solutions of this application are described as follows.

This application provides a neural network-based error compensation method for mass transfer of Mini-LED chips, comprising:
(S1) obtaining automated optical re-inspection results as first results, wherein the first results comprise data variables of each of the Mini-LED chips, and the data variables comprise a transfer status identifier, a first X-direction transfer error and a first Y-direction transfer error;
(S2) removing irrelevant variables from the data variables; and sorting the first results according to a transfer sequence followed by normalization to obtain a second result;
(S3) performing nearest-neighbor interpolation on a Mini-LED chip with a transfer status identifier being abnormal in the second result; according to an X-direction transfer error and a Y-direction transfer error in the second result, calculating a chip distance and a chip angular position in a polar coordinate system followed by removal of outliers; according to the chip angular position on a wafer, calculating a chip angle information and converting the chip angle information into a rectangular coordinate system information to calculate a differential of a path variable of each of the Mini-LED chips;
(S4) defining a multi-layer neural network model and a dropout ratio corresponding thereto; constructing a loss function based on the chip distance in the polar coordinate system and a predicted value thereof, and the chip angular position in the polar coordinate system and a predicted value thereof; updating a weight of the multi-layer neural network model through using an optimizer and the loss function, until no overfitting is observed after the chip distance in the polar coordinate system, the chip angular position in the polar coordinate system, the differential of the path variable and the second result in a test set are input into the multi-layer neural network model; and
(S5) generating a chip transfer path; inputting the chip transfer path into the multi-layer neural network model to obtain a predicted transfer error value; and performing mass transfer of the Mini-LED chips based on the predicted transfer error value.

In an embodiment, the data variables further comprise a substrate row, a substrate column, a camera X-axis coordinate, a camera Y-axis coordinate, a substrate X-axis coordinate, a substrate Y-axis coordinate, a chip angular position after transfer, the transfer status identifier, a wafer row, a wafer column, a wafer X-axis coordinate, a wafer Y-axis coordinate, the chip angular position on the wafer, a substrate serial number, a wafer serial number, an ejection mode and a transfer direction; and
the irrelevant variables comprise the camera X-axis coordinate, the camera Y-axis coordinate, the chip angular position after transfer, the transfer status identifier, the substrate serial number, the wafer serial number and the ejection mode.

In an embodiment, the step of generating the chip transfer path comprises:
(S51) rotating the wafer until a Mini-LED chip at a center of the wafer is parallel to a Y-axis of a camera;
(S52) controlling a camera to move to mark points at four right-angle vertices of each glass substrate to obtain position coordinates of each glass substrate;
(S53) controlling the camera to move to a position of each Mini-LED chip on the wafer to obtain position coordinates of each Mini-LED chip;
(S54) adjusting ranges of the substrate row, the substrate column, the wafer row and the wafer column, so that a target position matrix on each glass substrate is the same as a chip matrix on the wafer in size, and is in one-to-one correspondence to the chip matrix on the wafer in size; and
(S55) generating the chip transfer path based on the position coordinates of each glass substrate and the position coordinates of each Mini-LED chip on the wafer.

In an embodiment, the step of inputting the chip transfer path into the multi-layer neural network model to obtain the predicted transfer error value, and performing mass transfer of the Mini-LED chips based on the predicted transfer error value comprises:
(S56) inputting the chip transfer path into the multi-layer neural network model updated through step (S4) to obtain the predicted transfer error value; and converting the predicted transfer error value into a second X-direction transfer error and a second Y-direction transfer error;
(S57) subtracting the second X-direction transfer error from an X-axis coordinate of the position coordinates of each glass substrate, and subtracting the second X-direction transfer error from an X-axis coordinate of the position coordinates of each Mini-LED chip;
subtracting the second Y-direction transfer error from a Y-axis coordinate of the position coordinates of each glass substrate, and subtracting the Y-direction transfer error from a Y-axis coordinate of the position coordinates of each Mini-LED chip; and
obtaining an adjusted chip transfer path; and
(S58) based on the adjusted chip transfer path, placing the Mini-LED chips on the glass substrate to achieve mass transfer.

In an embodiment, the neural network-based error compensation method further comprises: after step (S58), performing flying imaging capture on the Mini-LED chip on the glass substrate to obtain transfer error data.

In an embodiment, in step (S3), if several consecutive Mini-LED chips with their transfer status identifier being abnormal are observed in the second result, forward and backward searching is performed to obtain nearest two Mini-LED chips with their transfer status identifier being normal; and values of an abnormal row are calculated based on equidistant distribution.

In an embodiment, in step (S3), the path variables comprise a substrate X-axis coordinate, a substrate Y-axis coordinate, a wafer X-axis coordinate and a wafer Y-axis coordinate; and
the step of calculating the differential of the path variables comprises:
obtaining path variables of a current Mini-LED chip;
obtaining path variables of a reference Mini-LED chip; and
subtracting the path variables of the reference Mini-LED chip from the path variables of the current Mini-LED chip to obtain an X-axis movement distance or a Y-axis movement distance of the glass substrate and the wafer.

In an embodiment, in step (S4), the multi-layer neural network model comprises an input layer, a fully connected layer, a forget gate, and an output layer; and
a forward propagation output of the multi-layer neural network model is expressed as:

$$Output = Act ( … Act ( Act ( {W}_{3} \cdot Ac t ( {W}_{2} \cdot Ac t ( {W}_{1} \cdot X + {b}_{1} ) + {b}_{2} ) + {b}_{3} ) ) ) ;$$

wherein Wᵢ represents a weight matrix, bᵢ represents a bias of an i-th layer, and Act represents an activation function.

In an embodiment, the loss function constructed based on the chip distance in the polar coordinate system, and the predicted value thereof, the chip angular position in the polar coordinate system and the predicted value thereof is expressed as:

$$loss = \frac{1}{m} {\sum }_{i = 1}^{m} \sqrt{( {R}_{i}^{2} + {\hat{R}}_{i}^{2} - 2 {R}_{i} \cdot {\hat{R}}_{i} cos {( {Theta}_{i} - )}^{2}} ;$$

wherein loss represents a calculation result of the loss function, m represents the number of samples, Rᵢ represents a real value of an i-th Mini-LED chip, \hat{R}ᵢ represents a predicted value of the i-th Mini-LED chip, Thetaᵢ represents an angular position of the i-th Mini-LED chip after transfer, and [symbol] represents a predicted rotation angle of the i-th Mini-LED chip; and the number of samples represent the number of data rows being input to the multi-layer neural network model, that is, the number of the Mini-LED chips after removal of outliers in a single transfer process.

In an embodiment, the step of updating the weight of the multi-layer neural network model through using the optimizer and the loss function according to the following formula:

$${W}^{t + 1} = {W}^{t} - η \cdot {∇}_{w} loss ( {W}^{t} ) ;$$

wherein W^{t+1} represents a weight of an updated multi-layer neural network model, W^{t} represents the weight of the multi-layer neural network model, η represents a learning rate, and V̅_{w} loss represents a gradient of the loss with respect to the weight of the multi-layer neural network model.

One of the technical solutions above has the following advantages or beneficial effects.

This application collects actual transfer data from each Mini-LED chip to enable precise identification and compensation of transfer errors, thereby solving problems that the Mini-LED chips cannot be positioned one by one. In view of multiple error sources in the Mini-LED transfer process, the neural network model is adopted to perform complex data process, which effectively captures and compensates errors. A generalization ability of the model is improved through an appropriate model structure and a dropout mechanism, solving problems that the sources of transfer errors are complex and difficult to accurately calculated through mathematical model caused by small size and high transfer frequency of the Mini-LED chips, and making it more stable is real application. Through automated pre-compensation method and reduced manual intervention, transfer accuracy of the Mini-LED chips is improved without t reducing the transfer efficiency of the Mini-LED chips.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In order to illustrate the technical solutions of this application or the prior art more clearly, the accompanying drawings required in the description of embodiments or the prior art will be briefly introduced below. It is obvious that the following accompanying drawings only show some embodiments of this application, and for those of ordinary skill in the art, other relevant accompanying drawings can also be obtained according to these drawings without making creative effort.

FIG. 1 is a flow chart of a neural network-based error compensation method for mass transfer of mini-light-emitting diode (Mini-LED) chips according to an embodiment of the present disclosure.

FIG. 2 is a flow chart for generating a chip transfer path of the neural network-based error compensation method according to an embodiment of the present disclosure.

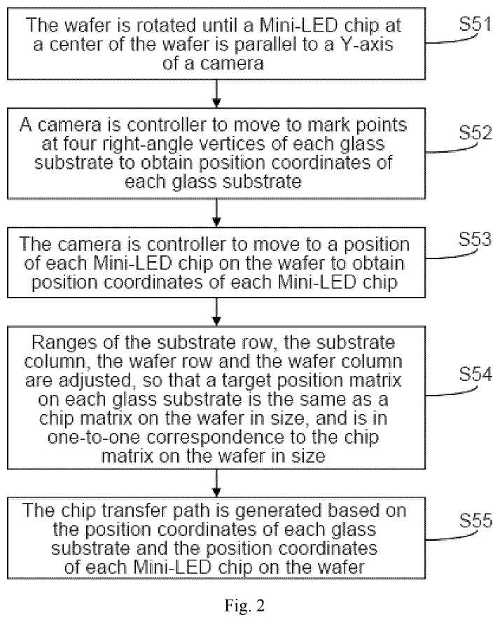

FIG. 3 is a flow chart for performing mass transfer of the Mini-LED chips of the neural network-based error compensation method according to an embodiment of the present disclosure.

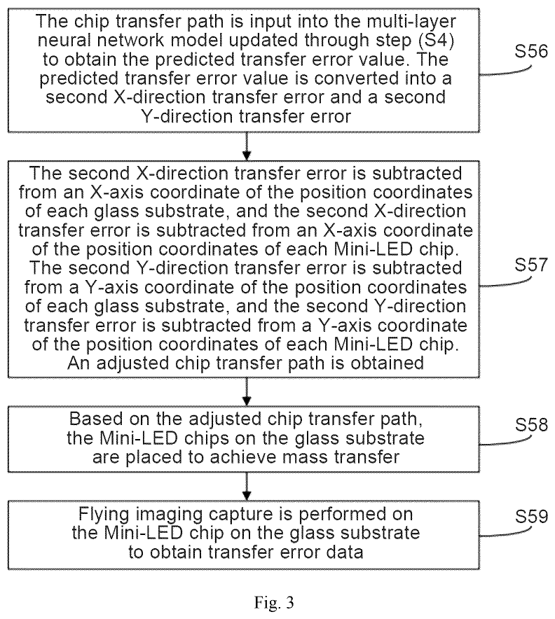

FIG. 4 is a comparison diagram of an X-axis pre-compensation error and an X-axis actual error of the neural network-based error compensation method according to an embodiment of the present disclosure.

FIG. 5 is a comparison diagram of a Y-axis pre-compensation error and a Y-axis actual error of the neural network-based error compensation method according to an embodiment of the present disclosure.

FIG. 6 is a comparison diagram of a plane pre-compensation error and a plane actual error of the neural network-based error compensation method according to an embodiment of the present disclosure.

### DETAILED DESCRIPTION OF EMBODIMENTS

The embodiments of the present disclosure are described in detail below. The embodiments are illustrated in the accompanying drawings, where identical or similar reference numerals indicate identical or similar elements or elements having identical or similar functions. The embodiments described in detail below with reference to the accompanying drawings are only exemplary and illustrative, and are not intended to limit the disclosure.

In the disclosure, it should be noted that the terms, such as “central”, “longitudinal”, “transverse”, “lengthwise”, “widthwise”, “thickness”, “up”, “down”, “left”, “right”, “vertical”, “horizontal”, “top”, “bottom”, “inner”, “outer”, “axial”, “radial”, “circumferential” and other directional indications used herein, are only used for illustrating relative position relationship and motion between components in a specific state (as shown in the accompanying drawings), rather than limiting the disclosure.

In addition, the terms “first” and “second” are only used for distinguishment rather than indicating or implying the relative importance or implicitly specifying the number of technical features indicated. Therefore, a feature defined with “first” or “second” may explicitly or implicitly indicates the inclusion of at least one of such features. As used herein, “multiple” means two or more unless otherwise clearly stated.

As used herein, unless otherwise expressly specified and limited, the terms “mounting”, “connection” and “linkage” should be interpreted in a broad sense. For example, it can be “fixed connection”, “removable connection” or “integral connection”; it can be “direct connection” or “indirect connection through an intermediate medium”; and it can be internal communication or interaction between two components. For those of ordinary skill in the art, the specific meaning of these terms can be understood in specific cases.

Due to the small size of Mini-LED chips, it is critical to ensure that each Mini-LED chip is accurately placed at its predetermined position. Excessive transfer error may lead to defects, such as poor electrical contact or incomplete bonding. Moreover, high transfer efficiency must be maintained to meet demands of mass production. The small size and high transfer frequency of the Mini-LED chips make sources of transfer errors more complex and difficult to accurately calculated through mathematical model. Continuous pin-ejector transfer is one of Mini-LED mass transfer technologies. The current continuous pin-ejector transfer adjusts relative positions among the needle, wafer, and glass substrate to control an overall transfer of Mini-LED chip landing positions.

However, such a compensation method can only minimize an average transfer error of the Mini-LED chips but cannot control transfer error of individual chips. In addition, due to high frequency of mass transfer, it is impractical to perform camera positioning prior to pin ejection during transfer of each Mini-LED chip, therefore, it is an urgent need for a method for compensating mass transfer errors of each Mini-LED chip before transfer.

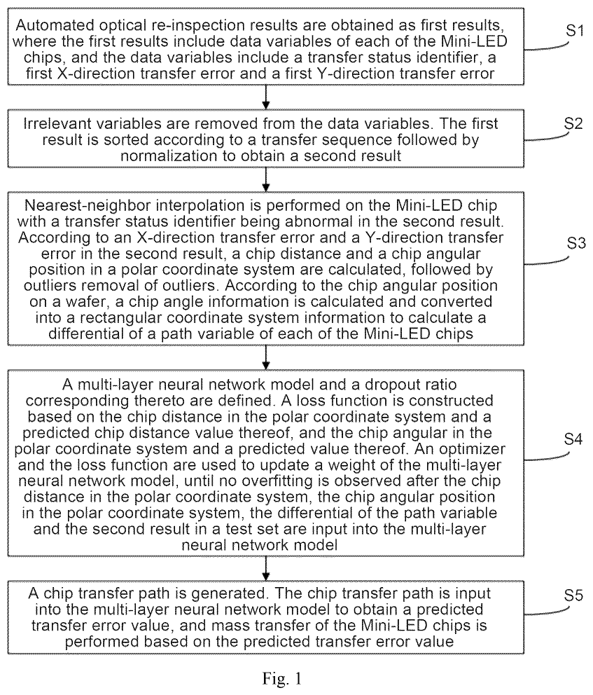

This application provides a neural network-based error compensation method for mass transfer errors of Mini-LED chips as shown in FIG. 1. The neural network-based error compensation method includes the following steps.
(S1) Automated optical re-inspection results are obtained as first results, where the first results include data variables of each of the Mini-LED chips, and the data variables include a transfer status identifier, a first X-direction transfer error and a first Y-direction transfer error.

In this step, an aim is to collect a transferred status information. Through re-inspection, variables such as position information and transfer status of each of the Mini-LED chips can be obtained, providing a foundation for subsequent analysis and model training.

Physical meanings of X-direction transfer errors OffsetX and Y-direction transfer errors OffsetY are respectively a distance between an actual position of each chip on a glass substrate after transfer and its target position. With the target position as an origin, coordinate axes are established along X and Y directions. The X-direction transfer errors OffsetX and the Y-direction transfer errors OffsetY represent planar coordinates (x, y) of the actual position.
(S2) Irrelevant variables are removed from the data variables. The first results are sorted according to a transfer sequence followed by normalization to obtain a second result.

Irrelevant variables refer to variables that are not utilized in the neural network-based error compensation method. Although such variables, generated by built-in software in a machine, may be beneficial for actual production, the presence of the irrelevant variables in the present disclosure may interfere with model learning and generalization. Therefore, the irrelevant variables need to be removed initially. Then, the data are rearranged according to a transfer sequence to ensure consistency of time series. Finally, min-max normalization is performed to linearly scale all features to an interval of [0, 1]. Such normalization can reduce scale differences among features, prevent some features from dominating during learning process, so as to improve model accuracy. In addition, such normalization also helps mitigate a risk of gradient explosion during subsequent model training.
(S3) Nearest-neighbor interpolation is performed on the Mini-LED chip with a transfer status identifier being abnormal in the second result. According to an X-direction transfer error and a Y-direction transfer error in the second result, a chip distance and a chip angular position in a polar coordinate system are calculated, and followed by removal of outliers. According to the chip angular position on a wafer, a chip angle information is calculated and converted into a rectangular coordinate system information to calculate a differential of a path variable of each of the Mini-LED chips.

Specifically, the Mini-LED chip with the transfer status identifier being abnormal is identified and subjected to interpolation. An average of all values from a previous row and a subsequent row are utilized as a value of an abnormal row, then the X-direction transfer errors OffsetX and the Y-direction transfer errors OffsetY are coupled to calculate the chip distance R and the chip position rotation angle Theta in the polar coordinates. Subsequently, the outliers are removed. It should be noted that the outliers refer to chips with a chip distance R greater than 50 μm, such chip can be detectable by vision inspection, but is in an abnormal state and is not representative for transfer error prediction. Therefore, these outliers need to be removed. The Mini-LED chip with the transfer status identifier being abnormal refer to those recorded as “Missing” in state after transfer. Then, a chip rotation angle DieAngle is used to calculate the chip angle information of the Mini-LED chip, where the chip angle information of the Mini-LED chip includes a sine SinDieAngle and a cosine CosDieAngle. The chip angle information of the Mini-LED chip is converted into the rectangular coordinate system information. The difference of path variables of each Mini-LED chip is calculated to represent a motion path of the machine before reaching the current chip position.
(S4) A multi-layer neural network model and a dropout ratio corresponding thereto are defined. A loss function is constructed based on the chip distance in the polar coordinate system, a predicted value thereof, and the chip angular position in the polar coordinate system and a predicted value thereto. An optimizer and the loss function are used to update a weight of the multi-layer neural network model, until no overfitting is observed after the chip distance in the polar coordinate system, the chip angular in the polar coordinate system, the differential of the path variables and the second result in a test set are input into the multi-layer neural network model.

This step includes a constructing and training process for one multi-layer neural network model. First, the multi-layer neural network model is defined and the dropout ratio corresponding thereto is set to prevent overfitting. The loss function incorporates a predicted chip distance error and a predicted angular position error, so as to ensure simultaneous optimization of these two objectives. Then, the weight of the multi-layer neural network model is updated through the optimizer to gradually improve performance. Finally, performance of the multi-layer neural network model is verified on the test set to ensure no overfitting is observed on the multi-layer neural network model, so as to enhance its generalization capability and practical effectiveness.
(S5) A chip transfer path is generated. The chip transfer path is input into the multi-layer neural network model to obtain a predicted transfer error value, and mass transfer of the Mini-LED chip is performed based on the predicted transfer error value.

After the model training is completed, the chip transfer path is input to predict errors that may occur during the actual transfer process. Prediction values would guide adjustments in position and rotation angle to optimize transfer performance. Through precise path planning, positional deviations caused by transfer errors can be minimized, so as to improve overall success rate of the transfer.

In an embodiment, the data variables further include a substrate row, a substrate column, a camera X-axis coordinate, a camera Y-axis coordinate, a substrate X-axis coordinate, a substrate Y-axis coordinate, a chip angular position after transfer, the transfer status identifier, a wafer row, a wafer column, a wafer X-axis coordinate, a wafer Y-axis coordinate, a chip rotation angle on the wafer, a substrate serial number, a wafer serial number, an ejection mode and a transfer direction; and the irrelevant variables include the camera X-axis coordinate, the camera Y-axis coordinate, the chip angular position after transfer, the transfer status identifier, the substrate serial number, the wafer serial number and the pin ejection mode.

In an embodiment, the camera X-axis coordinate and the camera Y-axis coordinate exhibit a one-to-one mapping with the substrate X-axis coordinate and the substrate Y-axis coordinate, resulting in high collinearity. Among the data input in the multi-layer neural network model, variables with high collinearity should be excluded, otherwise, it will lead to difficulties in weight learning and a decline in the generalization ability of the model method. Therefore, the camera X-axis coordinate and the camera Y-axis coordinate are removed.

The transfer status identifier and a status identifier after transfer have high collinearity, and represent the chip is transferred/absent. Owing to the data input in the multi-layer neural network model, variables with high collinearity should be excluded, therefore, the transfer status identifier should be removed. The chip angular position after transfer, like the X-direction transfer error and the Y-direction transfer error, is a result that can only be obtained after the transfer. The neural network-based error compensation method of the present disclosure is configured to perform pre-compensation on the motion path of the machine before the transfer, and the input data for training the neural network model should also be the data that can be obtained before the transfer. Therefore, the chip angular position after transfer needs to be excluded.

The substrate serial number, the wafer serial number and the pin ejection mode are used for material layout and planning in an actual production, however, the present disclosure focuses on error compensation during the transfer process of a single wafer, therefore, such three variables are removed.

In an embodiment, the step of the chip transfer path is generated includes the following steps.
(S51) The wafer is rotated until a Mini-LED chip at a center of the wafer is parallel to a Y-axis of a camera.
(S52) A camera is controller to move to mark points at four right-angle vertices of each glass substrate to obtain position coordinates of each glass substrate.
(S53) The camera is controller to move to a position of each Mini-LED chip on the wafer to obtain position coordinates of each Mini-LED chip.
(S54) Ranges of the substrate row, the substrate column, the wafer row and the wafer column are adjusted, so that a target position matrix on each glass substrate is the same as a chip matrix on the wafer in size, and is in one-to-one correspondence to the chip matrix on the wafer.
(S55) The chip transfer path is generated based on the position coordinates of each glass substrate and the position coordinates of each Mini-LED chip on the wafer.

In an embodiment, in a semiconductor production, each Mini-LED chip on the wafer needs to be aligned with a sight of the camera during imaging or processing, so as to minimize image distortion. The wafer is rotated to adjust the angle of the chip, so as to reduce average rotation angles of all the Mini-LED chips on the wafer, in such way, the center of the wafer is parallel to the Y-axis of the camera, so as to ensure optimal image capture. In order to realize effective chip transfer, sizes and layouts between the glass substrate and the wafer must be matched, that is, when an ejector pin of a pin ejection machine drops, it corresponds to coordinate values of the four axes including the substrate X-axis coordinate RulerX, the substrate Y-axis coordinate RulerY, the wafer X-axis coordinate DieX and the Y-axis coordinate DieY. In this step, the ranges of the rows and the columns are adjusted to achieve alignment. Based on the four axes including the substrate X-axis coordinate RulerX, the substrate Y-axis coordinate RulerY, the wafer X-axis coordinate DieX and the Y-axis coordinate DieY, define motion paths of main motion components: a glass substrate carrier platform and a wafer platform. Through adjusting ranges of rows and columns of the substrate and the wafer, layout consistency is ensured, enhancing production consistency and reliability and ensuring correspondence among the four coordinate axes, so as to improve transfer efficiency, reduce transfer time, and mitigate potential errors.

In an embodiment, the step of the chip transfer path is input into the multi-layer neural network model to obtain the predicted transfer error value, and mass transfer of the Mini-LED chip is performed based on the predicted transfer error value includes the following steps.
(S56) The chip transfer path is input into the multi-layer neural network model updated through step (S4) to obtain the predicted transfer error value. The predicted transfer error value is converted into a second X-direction transfer error and a second Y-direction transfer error.
(S57) The second X-direction transfer error is subtracted from an X-axis coordinate of the position coordinates of each glass substrate, and the second X-direction transfer error is subtracted from an X-axis coordinate of the position coordinates of each Mini-LED chip. The second Y-direction transfer error is subtracted from a Y-axis coordinate of the position coordinates of each glass substrate, and the second Y-direction transfer error is subtracted from a Y-axis coordinate of the position coordinates of each Mini-LED chip. An adjusted chip transfer path is obtained.
(S58) Based on the adjusted chip transfer path, the Mini-LED chips on the glass substrate is placed to achieve mass transfer.

In an embodiment, the multi-layer neural network learns complex patterns from extensive historical data (such as past transfer paths and their corresponding actual positions). When the data of the chip transfer path is input, the model utilizes its internal weights and activation functions to calculate and generate the predicted transfer error value. For example, after step (S55), the chip transfer path is saved as ManualReplanBondingPathOffset.csv, and ManualReplanBondingPathOffset.csv is input into the multi-layer neural network model updated through step (S4) to output the predicted transfer error value (\hat{R}, [symbol] ), then the predicted transfer error value is converted from polar coordinates to the X-direction transfer error O [symbol] X and the Y-direction transfer error O [symbol] Y, where the X-direction transfer error OffsetX and the Y-direction transfer error O [symbol] Y are calculated through the following formulas:

O [symbol] X=\hat{R}·cos( [symbol] ); and

O [symbol] Y=\hat{R}·sin( [symbol] ).

After the transfer error is obtained, positional correction is performed through coordinate adjustment. Specifically, original coordinates of the glass substrate and the chip minus the X-direction transfer error and the Y-direction transfer error, which reflects deviation between the actual position and the target position, ensuring that the chip is adjusted along a predetermined path. For example, a modified substrate X-axis coordinate is represented as RulerX=RulerX−O [symbol] X, a modified substrate Y-axis coordinate is represented as RulerY=RulerY−O [symbol] Y, a modified wafer X-axis coordinate is represented as DieX=DieX−O [symbol] X, and a modified wafer Y-axis coordinate is represented as DieY=DieY−O [symbol] Y. The modified motion path is saved as BondingDataAddOffset.csv, and is imported into a massive transfer die bonder.

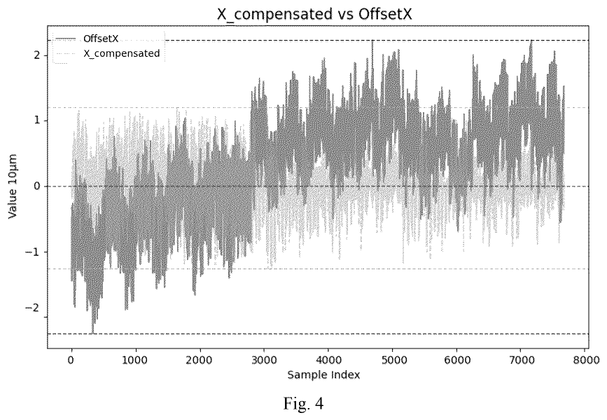

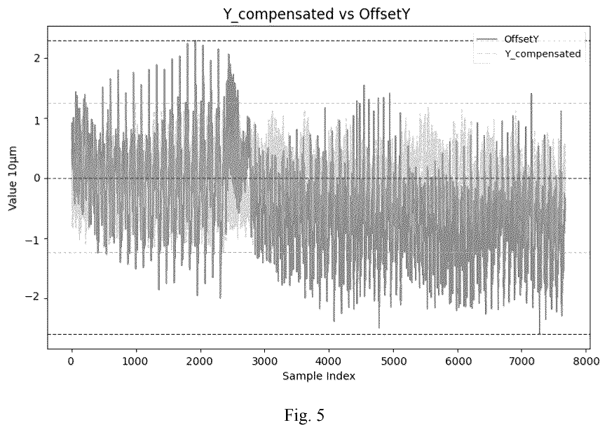

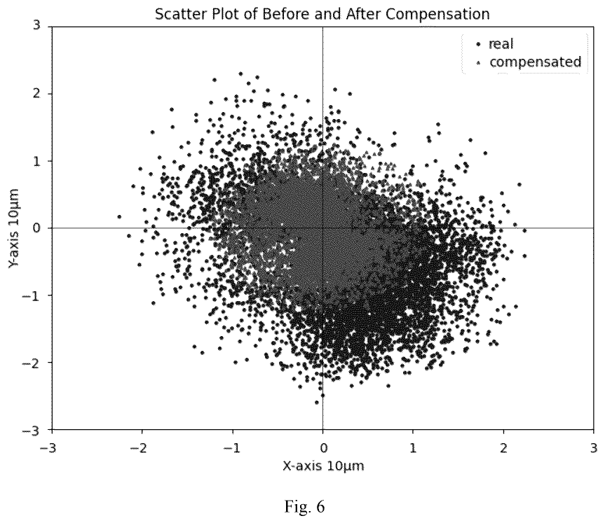

In step (S58), the die bonder is configured to transfer the Mini-LED chip according to BondingDataAddOffset.csv. An ejector pin is dropped at corresponding coordinates of each Mini-LED chip, so that the Mini-LED chips are placed on the glass substrate to realize mass transfer. Referring to FIGS. 4-5, solid lines represent true values of chip transfer errors, while dashed lines indicate compensation transfer errors after prediction by the multi-layer neural network and subsequent path modification. It can be observed that after pre-compensation, range and fluctuation of the chip transfer errors are reduced. In addition, referring to FIG. 6, circular scatter points represent actual landing positions of the Mini-LED chips relative to their target positions, and triangular scatter points show landing positions after pre-compensation. It can be observed that after pre-compensation, range of the chip transfer errors is reduced, and transfer accuracy is improved.

In an embodiment, the neural network-based error compensation method further includes the following steps. After step (S58), flying imaging capture is performed on the Mini-LED chip on the glass substrate to obtain transfer error data.

The flying imaging capture can rapidly capture actual positions of chips during the transfer process, compares the actual positions of chips with predetermined target positions, and allows real-time monitoring of transfer accuracy. The obtained transfer error data can be promptly fed back to the system, and facilitates dynamic adjustments in subsequent transfer, so as to enhance overall responsiveness and enable immediate detection of transfer deviations, which helps prevent the production of non-conforming products, and thereby improves good yield rates while reducing scrap rate.

In an embodiment, in step (S3), if several consecutive Mini-LED chips with the transfer status identifier being abnormal are observed in the second result, forward and backward searching is performed to obtain nearest two Mini-LED chips with their transfer status identifier being normal; and values of an abnormal row are calculated based on equidistant distribution.

The equidistant distribution ensures smooth data transitions, and prevents unnatural fluctuations caused by abrupt changes, resulting in a more coherent overall trend. The equidistant distribution is used to simplify interpolation process, making implementation more straightforward and efficient. It also helps align the trend of abnormal data with surrounding normal data, thereby enhancing reliability of prediction models.

In an embodiment, in step (S3), the path variables include the substrate X-axis coordinate, the substrate Y-axis coordinate, the wafer X-axis coordinate and the wafer Y-axis coordinate.

The step of the difference of path variables is calculated includes the following steps.

Path variables of a current Mini-LED chip are obtained.

Path variables of a reference Mini-LED chip are obtained.

The path variables of the reference Mini-LED chip are subtracted from the path variables of the current Mini-LED chip to obtain an X-axis movement distance or a Y-axis movement distance of the glass substrate and the wafer.

Specifically, for an i-th chip, data of current i-th row and n-th row are taken, and path variable value of the n-th row is subtracted from that of the i-th row, and is recorded as variables: a substrate X-axis coordinate difference diffRulerXk, a substrate Y-axis coordinate difference diffRulerYk, a wafer X-axis coordinate difference diffDieXk and a wafer Y-axis coordinate difference diffDieYk, where k=1, 2, 3 . . . n−1. A physical meaning of the substrate X-axis coordinate difference diffRulerXk is defined as follows: when the i-th chip is transferred, a distance of the glass substrate carrier platform moved along the X-direction compared to the i-n-th chip. A physical meaning of the substrate Y-axis coordinate difference diffRulerYk is defined as follows: when the i-th chip is transferred, a distance of the glass substrate carrier platform moved along the Y-direction the i-n-th chip. A physical meaning of the wafer X-axis coordinate difference diffDieXk is defined as follows: when the i-th chip is transferred, a distance of the wafer moved along the X-direction compared to the i-n-th chip. A physical meaning of the wafer Y-axis coordinate difference diffDieYk is defined as follows: when the i-th chip is transferred, a distance of the wafer moved along the Y-direction compared to the i-n-th chip.

In an embodiment, in step (S4), the multi-layer neural network model includes an input layer, a fully connected layer, a forget gate, and an output layer.

A forward propagation output of the multi-layer neural network model is expressed as:

$$Output = Act ( … Act ( Act ( {W}_{3} \cdot Act ( {W}_{2} \cdot Act ( {W}_{1} \cdot X + {b}_{1} ) + {b}_{2} ) + {b}_{3} ) ) ) ;$$

where Wᵢ represents a weight matrix, bᵢ represents a bias of an i-th layer, and Act represents an activation function.

In an embodiment, the forward propagation output of the multi-layer neural network model achieves complex nonlinear mapping through an application of multiple activation functions. Each layer in the formula performs a linear transformation using the weight matrix Wᵢ and the bias bᵢ, then a nonlinear feature is introduced through the activation function Act, so as to enhance an expression ability of the model. A layering structure enables the multi-layer neural network to learn complex patterns in the data, improve prediction accuracy and generalization capability. Through adjusting the weights and biases, the multi-layer neural network is continuously optimized to adapt to varying task requirements. Among them, the activation function can be a Relu function. The input layer is a mapping of input variables to the fully connected layer with each input node representing a feature variable in a data set. In the fully connected layer, each neuron is connected to all neurons in a previous layer, and the fully connected layer is configured to learn a mapping from the input variables to the target variables. In the forget gate, an output of a certain ration of neurons is randomly set to zero to force the network to learn more robust features, which is conducive to reducing overfitting on the training data and improving generalization ability of the model. The output layer is a mapping from the fully connected layer to the target variables. The dropout ratio is a ration of neurons in the forget gate whose outputs are set to zero relative to a total number of neurons.

In an embodiment, the loss function constructed based on the chip distance in the polar coordinate system, the predicted chip distance value, the chip angular position in the polar coordinate system and the predicted valueangular position is expressed as:

$$loss = \frac{1}{m} {\sum }_{i = 1}^{m} \sqrt{( {R}_{i}^{2} + {\hat{R}}_{i}^{2} - 2 {R}_{i} \cdot {\hat{R}}_{i} cos {( {Theta}_{i} - T )}^{2}} ;$$

where loss represents a calculation result of the loss function, m represents the number of samples, Rᵢ represents a real value of an i-th Mini-LED chip, \hat{R}ᵢ represents a predicted value of the i-th Mini-LED chip, Thetaᵢ represents an angular position of the i-th Mini-LED chip after transfer, and [symbol] represents a predicted angular position of the i-th Mini-LED chip; and the number of samples represent the number of data rows being input to the multi-layer neural network model, that is, the number of the Mini-LED chips after removal of outliers in a single transfer process.

In an embodiment, a physical meaning of loss is an average distance between predicted landing points and actual landing points of all chips. During training of the multi-layer neural network model, loss is minimized to ensure the predicted landing points converge as closely as possible to the actual landing points. Before the loss function is constructed, due to the fact that the transfer errors of all chips in a single transfer are affected by the accumulation of motion errors and exhibit time series characteristics, when the data is input into the model, it should be ensured that re-inspection result of a single transfer is input as an entire epoch. Therefore, it is necessary to create a data loader to input the re-inspection results with different lengths into the neural network.

In an embodiment, the step of the optimizer and the loss function are used to update the weight of the multi-layer neural network model as according to the following formula:

$${W}^{t + 1} = {W}^{t} - η \cdot {∇}_{w} loss ( {W}^{t} ) ;$$

where W^{t+1} represents a weight of an updated multi-layer neural network model, W^{t} represents the weight of the multi-layer neural network model, η represents a learning rate, and V̅_{w} loss represents a gradient of the loss with respect to the weight of the multi-layer neural network model.

In an embodiment, the optimizer may be an adaptive matrix estimation algorithm Adam. A process of the optimizer and the loss function are used to update the weight of the multi-layer neural network model is expressed as: W^{t+1}=W^{t}−η. V̅_{w} loss(W^{t}). Verify whether the model is overfitted is using the following steps. loss is calculated through utilizing the predicted values and actual values of the target variable in the test set, and a loss corresponding to the test set is compared with a loss corresponding to a training set and a verifying set. If the loss corresponding to the test set is similar to the loss corresponding to the training set and the verifying set, and no difference in magnitude is observed, it indicates that the model has generalization ability. Otherwise, it indicates that the model is overfitting and the weight of the multi-layer neural network model need to be updated.

In the description of the present disclosure, the terms “one embodiment”, “some embodiments”, “an illustrative embodiment”, “example”, “specific example”, “some examples” or other specific feature, structure, material, or characteristic described in connection with the embodiment or example are included in at least one embodiment or example of the present disclosure. In addition, the specific feature, structure, material, or characteristic described herein can be combined in an appropriate manner in any one or more embodiments or examples.

Although the disclosure has been described in detail with reference to the above embodiments, it should be understood by those of ordinary skill in the art that various changes, modifications, replacements and deformations can be made to this application without departing from the scope of the present disclosure. The present disclosure is defined by the appended claims.

What is claimed is:

1. A neural network-based error compensation method for mass transfer of mini-light-emitting diode (Mini-LED) chips, comprising:
(S1) obtaining automated optical re-inspection results as first results, wherein the first results comprise data variables of each of the Mini-LED chips, and the data variables comprise a transfer status identifier, a first X-direction transfer error and a first Y-direction transfer error;
(S2) removing irrelevant variables from the data variables; and sorting the first results according to a transfer sequence followed by normalization to obtain a second result;
(S3) performing nearest-neighbor interpolation on a Mini-LED chip with a transfer status identifier being abnormal in the second result; according to an X-direction transfer error and a Y-direction transfer error in the second result, calculating a chip distance and a chip angular position in a polar coordinate system followed by removal of outliers; according to the chip angular position on a wafer, calculating a chip angle information, and converting the chip angle information into a rectangular coordinate system information to calculate a differential of a path variable of each of the Mini-LED chips;
(S4) defining a multi-layer neural network model and a dropout ratio corresponding thereto; constructing a loss function based on the chip distance in the polar coordinate system and a predicted value thereof, and the chip angular position in the polar coordinate system and a predicted value thereof; updating a weight of the multi-layer neural network model using an optimizer and the loss function until no overfitting is observed after the chip distance in the polar coordinate system, the chip angular position in the polar coordinate system, the differential of the path variable and the second result in a test set are input into the multi-layer neural network model; and
(S5) generating a chip transfer path; inputting the chip transfer path into the multi-layer neural network model to obtain a predicted transfer error value; and performing mass transfer of the Mini-LED chips based on the predicted transfer error value.

2. The neural network-based error compensation method of claim 1, wherein the data variables further comprise a substrate row, a substrate column, a camera X-axis coordinate, a camera Y-axis coordinate, a substrate X-axis coordinate, a substrate Y-axis coordinate, a chip angular position after transfer, the transfer status identifier, a wafer row, a wafer column, a wafer X-axis coordinate, a wafer Y-axis coordinate, the chip angular position on the wafer, a substrate serial number, a wafer serial number, an ejection mode and a transfer direction; and
the irrelevant variables comprise the camera X-axis coordinate, the camera Y-axis coordinate, the chip angular position after transfer, the transfer status identifier, the substrate serial number, the wafer serial number and the ejection mode.

3. The neural network-based error compensation method of claim 2, wherein the step of generating the chip transfer path comprises:
(S51) rotating the wafer until a Mini-LED chip at a center of the wafer is parallel to a Y-axis of a camera;
(S52) controlling the camera to move to mark points at four right-angle vertices of each glass substrate to obtain position coordinates of each glass substrate;
(S53) controlling the camera to move to a position of each Mini-LED chip on the wafer to obtain position coordinates of each Mini-LED chip;
(S54) adjusting ranges of the substrate row, the substrate column, the wafer row and the wafer column, so that a target position matrix on each glass substrate is the same as a chip matrix on the wafer in size, and is in one-to-one correspondence to the chip matrix on the wafer; and
(S55) generating the chip transfer path based on the position coordinates of each glass substrate and the position coordinates of each Mini-LED chip on the wafer.

4. The neural network-based error compensation method of claim 3, wherein the step of inputting the chip transfer path into the multi-layer neural network model to obtain the predicted transfer error value, and performing mass transfer of the Mini-LED chips based on the predicted transfer error value comprises:
(S56) inputting the chip transfer path into the multi-layer neural network model updated through step (S4) to obtain the predicted transfer error value; and converting the predicted transfer error value into a second X-direction transfer error and a second Y-direction transfer error;
(S57) subtracting the second X-direction transfer error from an X-axis coordinate of the position coordinates of each glass substrate, and subtracting the second X-direction transfer error from an X-axis coordinate of the position coordinates of each Mini-LED chip;
subtracting the second Y-direction transfer error from a Y-axis coordinate of the position coordinates of each glass substrate, and subtracting the second Y-direction transfer error from a Y-axis coordinate of the position coordinates of each Mini-LED chip; and
obtaining an adjusted chip transfer path; and
(S58) based on the adjusted chip transfer path, placing the Mini-LED chips on the glass substrate to achieve mass transfer.

5. The neural network-based error compensation method of claim 4, further comprising:
after step (S58), performing flying imaging on the Mini-LED chips on the glass substrate to obtain transfer error data.

6. The neural network-based error compensation method of claim 1, wherein in step (S3), if several consecutive Mini-LED chips with their transfer status identifiers being abnormal are observed in the second result, forward and backward searching is performed to obtain nearest two Mini-LED chips with their transfer status identifiers being normal, and values of an abnormal row are calculated based on equidistant distribution.

7. The neural network-based error compensation method of claim 1, wherein in step (S3), the path variables comprise a substrate X-axis coordinate, a substrate Y-axis coordinate, a wafer X-axis coordinate and a wafer Y-axis coordinate; and
the step of calculating the differential of the path variables comprises:
obtaining path variables of a current Mini-LED chip;
obtaining path variables of a reference Mini-LED chip; and
subtracting the path variables of the reference Mini-LED chip from the path variables of the current Mini-LED chip to obtain an X-axis movement distance or a Y-axis movement distance of the glass substrate and the wafer.

8. The neural network-based error compensation method of claim 1, wherein in step (S4), the multi-layer neural network model comprises an input layer, a fully connected layer, a forget gate, and an output layer; and
a forward propagation output of the multi-layer neural network model is expressed as:
$$Output = Act ( … Act ( Act ( {W}_{3} \cdot Act ( {W}_{2} \cdot Act ( {W}_{1} \cdot X + {b}_{1} ) + {b}_{2} ) + {b}_{3} ) ) ) ;$$
wherein Wᵢ represents a weight matrix, bᵢ represents a bias of an i-th layer, and Act represents an activation function.

9. The neural network-based error compensation method of claim 1, wherein the loss function constructed based on the chip distance in the polar coordinate system and the predicted value thereof, and the chip angular position in the polar coordinate system and the predicted value thereof is expressed as:
$$loss = \frac{1}{m} {\sum }_{i = 1}^{m} \sqrt{( {R}_{i}^{2} + {\hat{R}}_{i}^{2} - 2 {R}_{i} \cdot {\hat{R}}_{i} cos {( {Theta}_{i} - T )}^{2}} ;$$
wherein loss represents a calculation result of the loss function, m represents the number of samples, Rᵢ represents a real value of an i-th Mini-LED chip, \hat{R}ᵢ represents a predicted value of the i-th Mini-LED chip, Thetaᵢ represents an angular position of the i-th Mini-LED chip after transfer, and [symbol] represents a predicted angular position of the i-th Mini-LED chip.

10. The neural network-based error compensation method of claim 9, wherein step of updating the weight of the multi-layer neural network model through using the optimizer and the loss function according to the following formula:
$${W}^{t + 1} = {W}^{t} - η \cdot {∇}_{w} loss ( {W}^{t} ) ;$$
wherein W^{t+1} represents a weight of an updated multi-layer neural network model, W^{t} represents the weight of the multi-layer neural network model, η represents a learning rate, and V̅_{w} loss represents a gradient of the loss with respect to the weight of the multi-layer neural network model.
